(19) United States
(12) Patent Application Publication
(10) Pub. No.: US 2004/0079749 A1
(43) Pub. Date: Apr. 29, 2004

(54) Multi-tank water heater

(76) Inventors: Randy S. Young, Lilburn, GA (US); Earl C. Meggison JR., Lilburn, GA (US)

Correspondence Address: Paul E. Franz, Jones, Day, Reavis & Pogue, North Point, 901 Lakeside Avenue, Cleveland, OH, 44114, US

(21) Appl. No.: 10/281,580

(22) Filed: Oct. 28, 2002

(51) Int. Cl. H05B 1/02

(52) U.S. Cl. 219/486; 219/483

(57) ABSTRACT

A water heater for providing heated water to one or more users includes a first and second tank enclosed in a shell an a mode selection device that is operable to switch between a first selected mode and a second selected mode. The first tank is for storing water in a heated state and for providing water in the heated state during the first and second selected modes. The second tank is for storing water in an unheated state during the first selected mode and for storing water in a heated state and for providing water in the heated state during a second selected mode.

### BACKGROUND

1. Field of the Invention

The present invention relates to storage water heaters. In particular, the present invention relates to storage water heaters having two or more tanks.

2. Description of the Related Art

A variety of water heaters are available, including storage water heaters, demand water heaters, heat pump water heaters, tankless coil water heaters, indirect water heaters, and solar water heaters. One of the most popular water heater designs is the storage tank water heater. The storage tank water heater stores heated water in a tank. The heated water is provided through an outlet from the tank, and is replaced by unheated water through an inlet to the tank. A control device, typically comprising a thermostat, monitors the water temperature in the tank and activates a heating device to heat the stored water when the stored water falls below a certain temperature.

The water in the storage tank water heater cools from the drawing of heated water from the tank, which causes unheated water to flow into the tank, or from standby heat loss, which is caused by natural radiation heat loss. One way to minimize standby heat loss is by installing a water heater with a smaller storage tank. How small the water heater can be depends on the number of individuals to be served. For example, in a household of up to three individuals, a 50 gallon storage tank water heater is commonly recommended; in a household of more than three and up to seven individuals, an 80 gallon storage tank is commonly recommended.

Depletion of stored heated water in smaller capacity storage tank water heaters is a common problem in a household demanding more than the recommend capacity of the water heater. For example, a 40 gallon water heater may adequately supply a household of two individuals with heated water; however, if the household infrequently requires a heightened demand, such as in the case of accommodating guests for several days, the same 40 gallon water heater may not be able to adequately supply the household with heated water. Purchasing a larger water heater for the household may be wasteful, however, as the heightened demand occurs only infrequently, and the larger capacity water heater has a greater standby heat loss. Likewise, connecting another separate water heater in series with the original 40 gallon water heater will also result in additional standby heat loss.

### SUMMARY

A water heater for providing heated water to one or more users includes a first and second tank enclosed in a shell and a mode selection device that is operable to switch between a first selected mode and a second selected mode. The first tank is for storing water in a heated state and for providing water in the heated state during the first and second selected modes. The second tank is for storing water in an unheated state during the first selected mode and for storing water in a heated state and for providing water in the heated state during a second selected mode.

### BRIEF DESCRIPTION OF THE DRAWINGS

FIG. 1 is a schematic view of a multi-tank water heater including a first tank positioned below a second tank, wherein both tanks are heated by electric heating elements;

FIG. 2 is a schematic view of another multi-tank water heater including a first tank positioned below a second tank, wherein both tanks are heated by fuel burners;

FIG. 3 is a schematic view of another multi-tank water heater including a first tank positioned below a second tank, wherein the first tank is heated by a fuel burner and the second tank is heated by an electric heating element;

FIG. 4 is a schematic view of another multi-tank water heater including a first tank positioned above a second tank, wherein both tanks are heated by electric heating elements;

FIG. 5 is a schematic view of another multi-tank water heater including first and second tanks positioned side-by-side;

FIG. 6 is a schematic view of another multi-tank water heater including a first tank positioned below a second tank, wherein both tanks are heated by electric heating elements and enclosed in a tank hull;

FIG. 7 is a schematic view of another multi-tank water heater including a first tank positioned inside a circular opening defined by a second tank;

FIG. 8 is a schematic view of another multi-tank water heater including first and second tanks operatively associated with mode valves so that the first tank can be connected in series with the second tank;

FIG. 9 is a schematic view of another multi-tank water heater including first and second tanks operatively associated with mode valves so that the first tank can be connected in parallel with the second tank; and

FIG. 10 is a block diagram of multi-tank water heater system including a remotely located mode selection device operable to receive manual selection data and selection data over a network.

### DETAILED DESCRIPTION

Throughout the drawings, the same or similar reference numerals are applied to the same or similar parts and elements, and thus the description of the same or similar parts and elements will be omitted or simplified when possible.

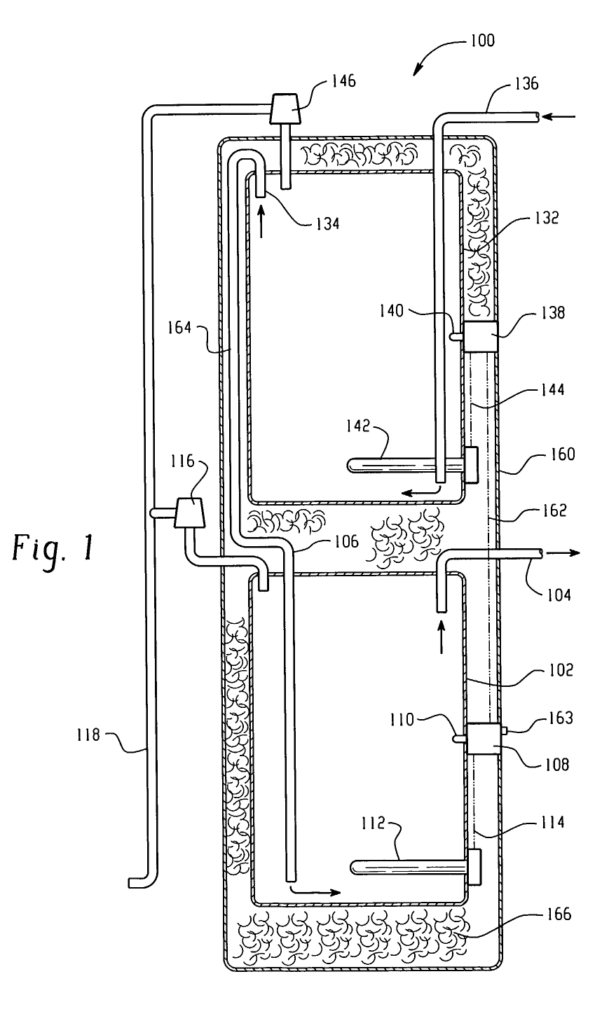

FIG. 1 is a schematic view of a first embodiment of a multi-tank water heater 100. The water heater 100 includes a first tank 102 having a first outlet 104 and a first inlet 106. Heated water is drawn from the first outlet 104, which causes water to enter the bottom of the first tank 102 via the first inlet 106.

A first controller 108 is coupled to a sensor 110 to monitor the water temperature in the first tank 102. The first controller 108 is operable in both a first mode and a second mode to activate a first electric heating element 112 via control line 114 if the temperature of the water in the first tank 102 falls below a certain low reference temperature. Similarly, the first controller 108 is further operable to deactivate the first electric heating element 112 via control line 114 if the temperature of the water in the first tank 102 reaches a certain high reference temperature.

A first pressure relief valve 116 is operable to open if pressure in the first tank 102 exceeds a safety level. Heated water is vented through a drain pipe 118 when the first pressure relief valve 116 is opened.

A second tank 132 is positioned above the first tank 102. The second tank 132 has a second outlet 134 and a second inlet 136. The second inlet 136 is connected to an unheated water supply, such as a water line that provides water to a household. Water is drawn from the second outlet 134, which causes water to enter the bottom of the second tank 132 via the second inlet 136.

A second controller 138 is coupled to a sensor 140 to monitor the water temperature in the second tank 132. The second controller 138 is operable in the second mode to activate a second electric heating element 142 via control line 144 if the temperature of the water in the second tank 132 falls below a certain low reference temperature. Similarly, the second controller 138 is further operable in the second mode to deactivate the second electric heating element 142 via control line 144 if the temperature of the water in the second tank 132 reaches a certain high reference temperature. In the first mode, the second electric heating element 142 is not activated.

A second pressure relief valve 146 is operable to open if pressure in the second tank 132 exceeds a safety level. Heated water is vented through a drain pipe 118 when the second pressure relief valve 146 is opened.

The first and second tanks 102 and 132 are enclosed within a shell 160, which is typically a light metal housing defining the exterior of the water heater 100. The first and second controllers 108 and 138 are coupled via a control line 162 inside the shell 160. A mode selection device 163 operable to select between the first and second modes and control the controllers 108 and 138 accordingly is placed on the exterior of the shell 160. A coupling pipe 164 couples the first inlet 106 of the first tank 102 to the second outlet 134 of the second tank 132. Enclosed within the shell 166 and surrounding the first and second tanks 102 and 132 is an insulation material 166 to minimize standby heat loss.

As previously described, the first controller 108 provides a thermostat control function in both the first and second modes, and the second controller 138 provides a thermostat control function only in the second mode, as the second electric heating element 142 is not activated in the first mode. Thus, in the first mode, only the first tank 102 stores heated water, and the second tank 132 stores unheated water. Therefore, when heated water is drawn from the first outlet 104 during the first mode, unheated water is provided at the first inlet 106 via coupling pipe 164, which is connected to the second outlet 134 of the second tank 132. The resulting water drawn from the second tank 132 is provided at the second inlet 136. Accordingly, water is continuously cycled through both the first and second tanks 102 and 132.

In the second mode, both the first and second controllers 108 and 138 provide a thermostat control function for the first and second tanks 102 and 132, respectively. Thus, the first and second tanks 102 and 132 store water in a heated state. Therefore, when heated water is drawn from the first outlet 104 during the second mode, heated water is provided at the first inlet 106 via coupling pipe 164, which is connected to the second outlet 134 of the second tank 132. Accordingly, in the second mode, the hot water storage capacity of the water heater 100 is increased by the capacity of the second tank 132.

The mode selection device 163 is operable to select between the first and second modes. The mode selection device 163 is illustratively placed on the outside of the shell 160, but can also be remotely located. For example, if the water heater 100 is located in the basement of a household, the mode selection device 160 can be integrated into a thermostat on the main floor of the household, thus allowing an occupant to select between the first and second modes without going down into the basement.

In one embodiment, the mode selection device 163 is a switch that prevents activation of the second controller 138 and the second electric heating element 142 during the first mode by disconnecting the second controller 138 and the second heating element 142 from a power source. The mode selection device allow power to be provided to the second controller 138 and the second electric heating element 142 during the second mode.

In another embodiment, the mode selection device 163 prevents activation of the second electric heating element 142 during the first mode by proving a control signal to the second controller 138 via the control line 162. When the control signal is present, the second controller 138 will not activate the second electric heating element 142. The control signal is removed during the second mode. Other configurations and embodiments of the mode selection device 163 that effectively preclude the heating of water stored in the second tank 138 during the second mode may also be implemented.

The particular configuration of the water heater 100 as show in FIG. 1 is illustrative only. For example, while the first tank 102 and second tank 132 are depicted as having similar capacity, the capacity of the first tank 102 as compared to the second tank 132 may vary. Illustratively, the first tank 102 may be a 30 gallon tank and the second tank 132 may be a 50 gallon tank. Similarly, the first tank 102 may be a 40 gallon tank, and the second tank 132 may be a 25 gallon tank. Other tank sizes may likewise be used.

Additionally, the first and second controllers 108 and 138 may be combined into one unit. Thus, a single controller can be connected to the sensors 110 and 140 and electric heating elements 112 and 142 and control the heating of both the first and second tanks 102 and 132 in both modes accordingly. Likewise, the switching device 163 can be combined with the single controller, thus placing all electronics and control circuitry in a single control device, or even on a single printed circuit board.

The water heater 100 as described in FIG. 1 thus provides a household or other location requiring the provisioning of heated water with a multi-capacity storage tank water heater that is essentially transparent except for the mode selection device 163.

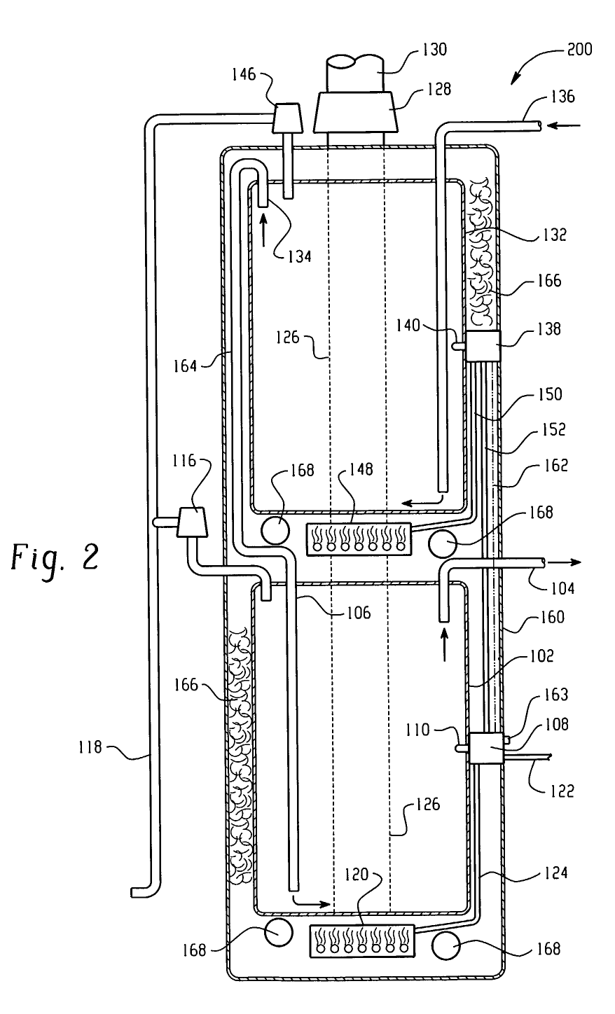

While the water heater 100 as depicted in FIG. 1 utilizes electric heating elements 112 and 142, the embodiments are not limited to electric heating devices. FIG. 2 provides a schematic view a multi-tank water heater 200 embodiment that utilizes fuel burners 120 and 148 to heat water stored in the first and second tanks 102 and 132, respectively. The fuel burners 120 and 148 are illustratively natural gas burners. The first fuel burner 120 receives fuel from a fuel supply line 122. The first controller 108, among other things, operates as a control valve, allowing fuel to flow from the fuel supply line 122 to the first fuel burner 120 via fuel supply line 124. A flue 126 extends through the first and second tanks 102 and 132, connecting to a draft hood 128 and a vent pipe 130. The insulation 166 is recessed from the first and second fuel burners 120 and 148, and the shell 160 further includes combustion vents 168.

The second fuel burner 148 receives fuel from a fuel supply line 150. The second controller 138, among other things, operates as a control valve, allowing fuel to flow from the fuel supply line 152 to the second fuel burner 148 via fuel supply line 150. The fuel supply line 152 is also connected to fuel supply line 122 via the first controller 122.

In a similar manner as described with respect to FIG. 1, the first controller 108 provides a thermostat control function in both the first and second modes, and the second controller 138 provides a thermostat control function only in the second mode. In the first mode, the second fuel burner 148 is not activated. Thus, in the second mode, the hot water storage capacity of the water heater 200 is increased by the capacity of the second tank 132.

The mode selection device 163 operates in a similar manner as previously described. In one embodiment, the mode selection device 163 is a switch that prevents activation of the second controller 138 and the second fuel burner 148 during the second mode by disconnecting the second controller 138 from a power source and further precluding the provisioning of fuel through fuel line 152. Power and fuel to the second controller 138 and the second fuel burner 148 is restored during the first mode.

In another embodiment, the mode selection device 163 prevents activation of the second fuel burner during the second mode by providing a control signal to the second controller 138 via the control line 162. When the control signal is present, the second controller 138 will not activate the second fuel burner 148. The control signal is removed during the first mode. Other configurations and embodiments of the mode selection device 163 that effectively preclude the heating of water stored in the second tank 138 during the second mode may be implemented.

The first and second controllers 108 and 138 may be combined in one unit. Thus, a single controller can be connected to the sensors 110 and 140 and provide fuel to the first fuel burner 120 as shown and to the second fuel burner via a separate fuel supply line coupling the second fuel burner 148 to the single controller. The single controller thereby controls the heating of both the first and second tanks 102 and 132 in the first and second modes accordingly. Likewise, the switching device 163 can be combined with the single controller, thus placing all electronics, control circuitry and gas valves in a single control device.

In the embodiment of FIG. 2, the exhaust gases and heated air provided by the fuel burner 120 also heat the water in the second tank 132 as the gases travel upward through the flue 126 to the vent pipe 130 during both the first and second modes. In the first mode, however, the water stored in the second tank 132 is not fully heated to the desired temperature, as most of the thermal energy provided by the fuel burner 120 is absorbed by the first tank 102. Nevertheless, the water stored in the second tank 132 is heated to a warmer state than as initially received via the cold water inlet 136. Thus, when the water heater 200 is switched to the second mode, less energy is required to heat the water in the second tank 132 to the desired temperature.

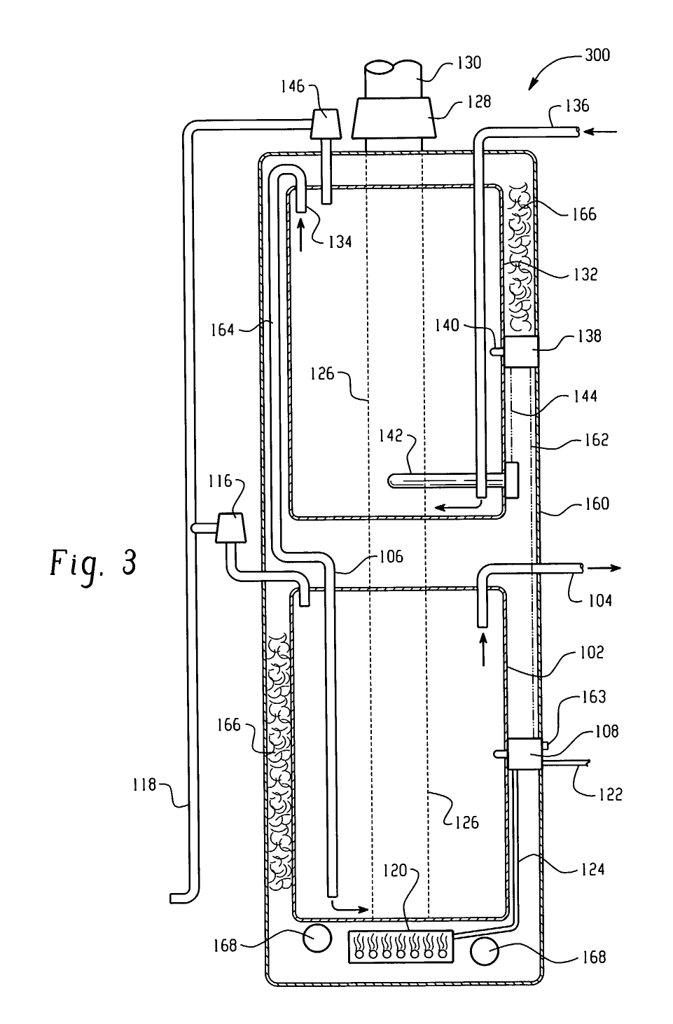

Yet another embodiment is depicted in FIG. 3, which provides a schematic view of another multi-tank water heater 300 including a first tank 102 positioned below a second tank 132, wherein the first tank 102 is heated by a fuel burner 120 and the second tank is heated by an electric heating element 142. In this embodiment, the second tank 132, although heated by the electric heating element 142, includes the flue 126 associated with the first fuel burner 120. The electric heating element 142 is disposed at an angle so that it does not interfere with the flue 126. The water heater 300 thus provides a primary gas heated storage water heater with an electrically heated auxiliary tank. Additionally, the second tank 132 absorbs excess heat provided by the fuel burner 120 in the same manner as described with respect to the second tank 132 in the water heater 200 of FIG. 2.

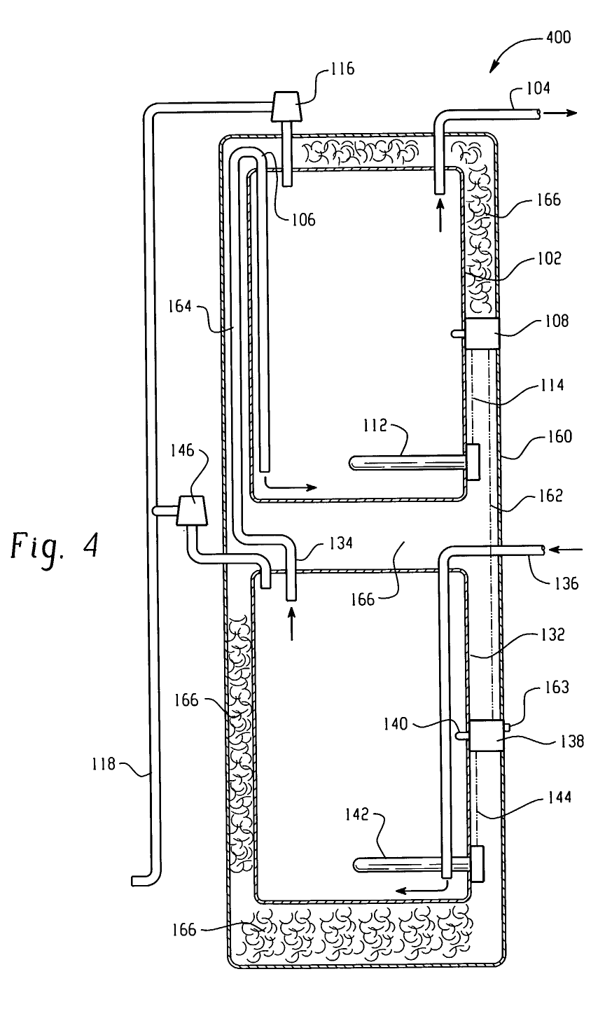

Of course, other multi-tank water heater configurations are possible. For example, the first tank 102 may be heated by an electric heating element 142, and the second tank 132 may be heated by a fuel burner 148. Additionally, the first tank 102 need not be placed below the second tank 132. FIG. 4 depicts another multi-tank water heater embodiment 400 that includes a first tank 102 positioned above a second tank 132. Aside from the placement of the first and second tanks 102 and 132, the water heater 400 operates in a similar manner as the embodiments of FIGS. 1-3.

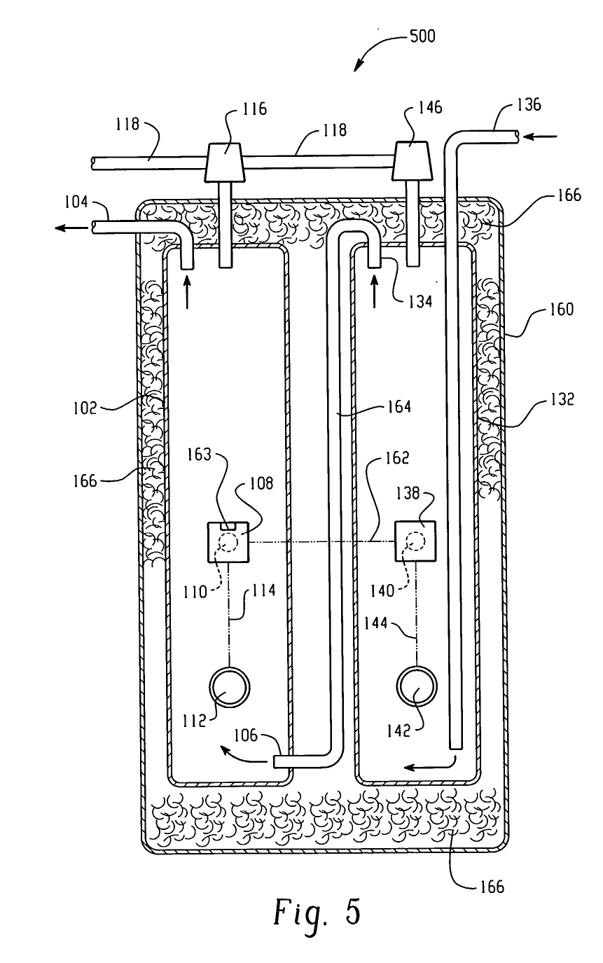

While the embodiments depicted in FIGS. 1-4 show the first and second tanks 102 and 132 vertically displaced, the first and second tanks 102 and 132 may also be placed in a side-by-side configuration, as shown in FIG. 5. While the first and second tanks 102 and 132 of the water heater 500 of FIG. 5 are heated by first and second electric heating elements 112 and 142, one or both of the first and second tanks 102 and 132 may instead be heated by first and second fuel burners 120 and 148, respectively. Thus, aside from the placement and the physical dimensions of the first and second tanks 102 and 132, the water heater 500 operates in a similar manner as the embodiments of FIGS. 1-4.

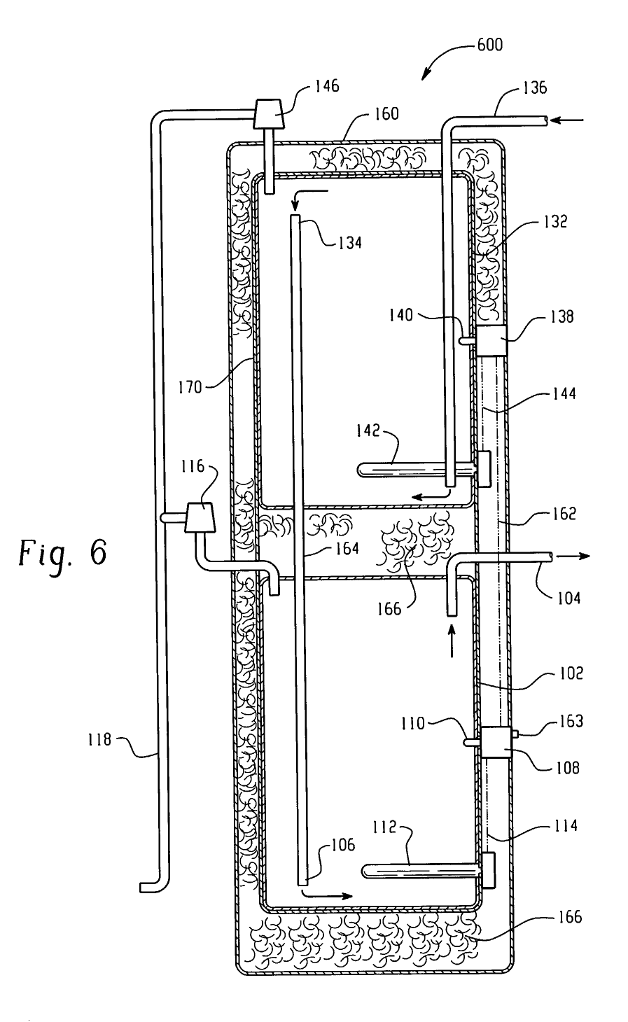

Another embodiment comprises the first and second tanks enclosed in a single tank hull 170. As shown in FIG. 6, a multi-tank water heater 600 includes the first tank 102 positioned below the second tank 132 in a single tank hull 170. A coupling pipe 164 couples the first inlet 106 of the first tank 102 to the second outlet 134 of the second tank 132. A space between the first and second tanks 102 and 132 may be filled with insulation 166.

While the first and second tanks 102 and 132 of the water heater 600 of FIG. 6 are heated by first and second electric heating elements 112 and 142, in another embodiment the first tank 102 is heated by a first fuel burner 120, and the flue 126 extends through the first and second tanks 102 and 132 in the tank hull 170. In all other respects, the water heater 600 operates in a similar manner as the embodiments of FIGS. 1-5.

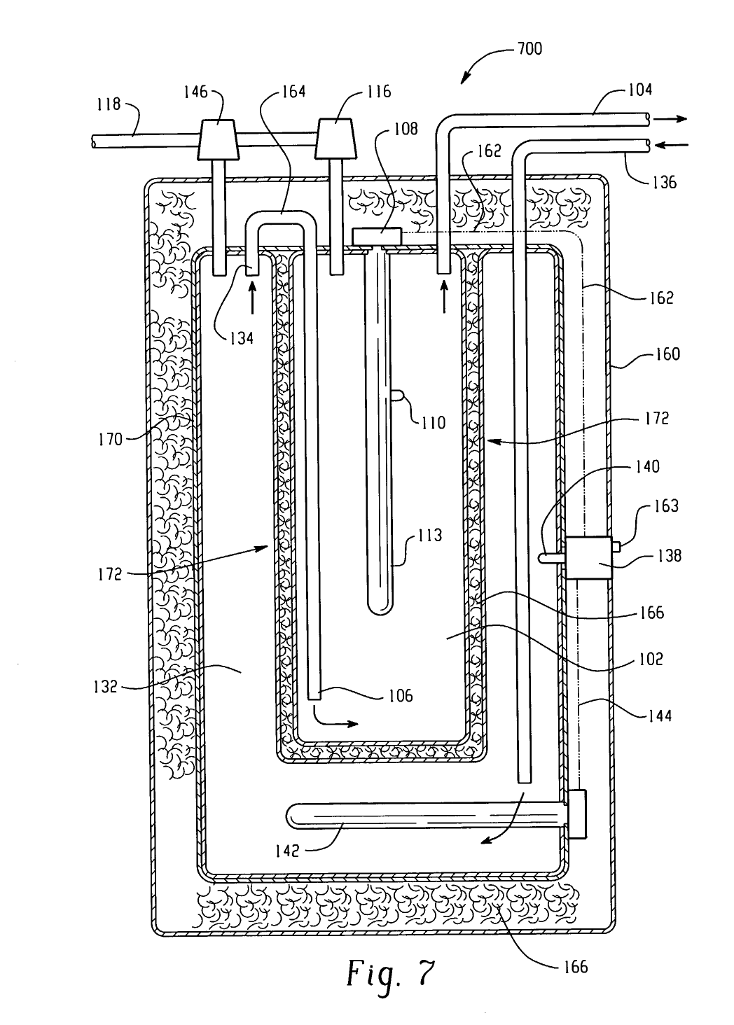

FIG. 7 provides a schematic view of another multi-tank water heater 700 including the first tank 102 positioned inside a circular region 172 defined by the second tank 132. An insulation layer 166 insulates the first tank 102 from the second tank 132. The first tank 102 is heated by a vertically displaced electric heating element 113, and the sensor 110 is likewise displaced from the top of the first tank 102. Both the first and second tanks 102 and 132 are enclosed within a tank hull 170. In all other respects, the water heater 600 operates in a similar manner as the embodiments of FIGS. 1-6.

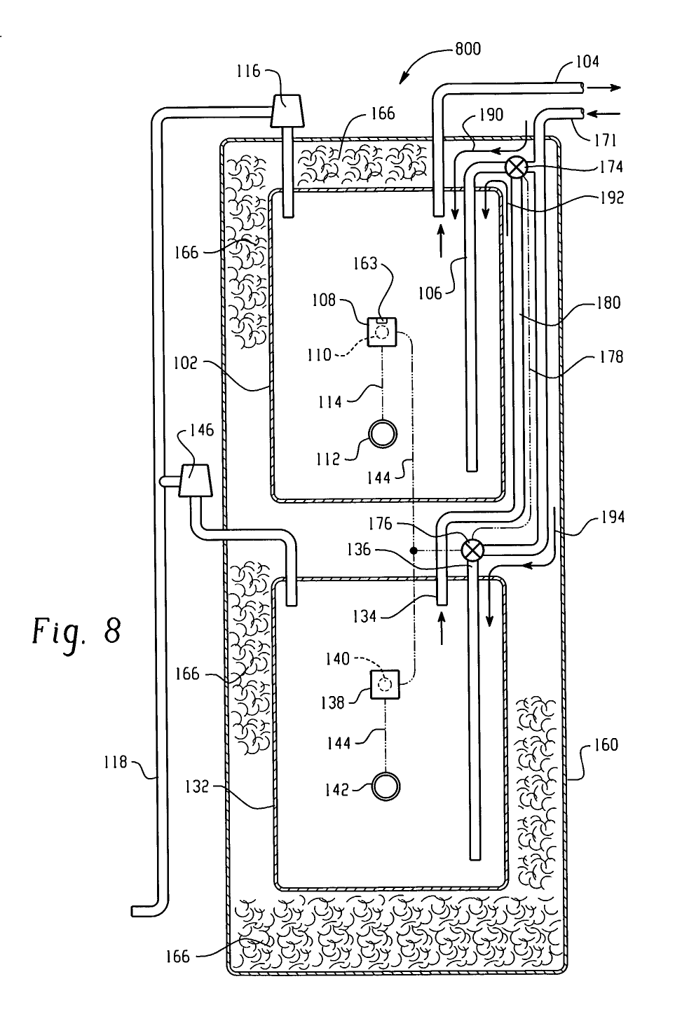

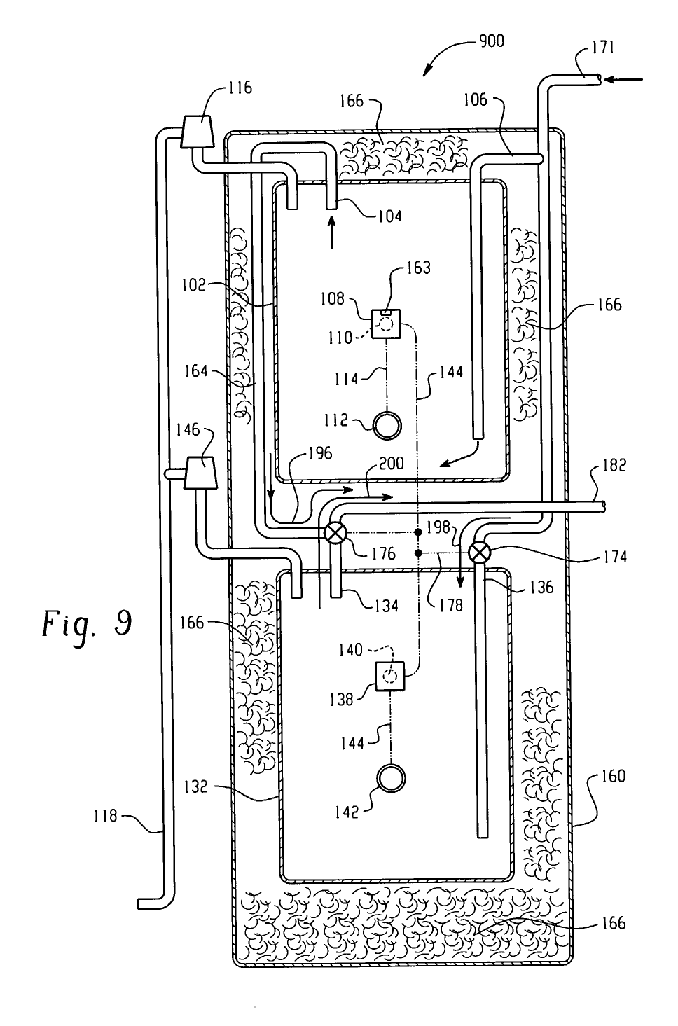

While the embodiments described above show the first tank 102 in series with the second tank 132 so that the first tank 102 receives water from the second tank 132, the multi-tank water heater is not limited to this particular configuration. In the embodiments described in FIGS. 8 and 9, mode valves are operatively associated with the first and second inlets 104 and 134 and the first and second outlets 106 and 136 to selectively change the flow of water through the first and second tanks 102 and 132. In FIG. 8, a multi-tank water heater 800 includes a first mode valve 174 operatively associated with the first inlet 106, the second outlet 134 via an inlet coupling pipe 180, and a cold water inlet 17 1. Additionally, a second mode valve 176 is operatively associated with the second inlet 136 and the cold water inlet 171. The mode valves 174 and 176 are controlled by a control line 178 coupled to the first controller 108.

In the first mode, the mode valve 174 is positioned so that water flows from the cold water inlet 171 to the first inlet 106, as indicated by the arrow 190, and water flow from the second outlet 134 is blocked. The second mode valve 176 is positioned to block water flow from the cold water inlet 171 to the first inlet 136.

Conversely, in the second mode, the first mode valve 174 is positioned to block water flow from the cold water inlet 171 to the first inlet 106, and to allow water flow from the inlet coupling pipe 180 to the first inlet 106, as indicated by arrow 192. The second mode valve is positioned to allow water flow from the cold water inlet 171 to the second inlet 136, as indicated by arrow 194. Thus, in the first mode, only the first tank 102 receives water and the second tank 132 is disconnected. In the second mode, the first and second tanks 102 and 132 are series connected so that the first tank 102 receives water from the second tank 132. In all other respects, the water heater 800 operates in a similar manner as the embodiments of FIGS. 1-7.

The first and second mode valves 174 and 176 may also be configured to connect the second tank 132 to the first tank 102 in parallel during the second mode. In FIG. 9, a multi-tank water heater 900 includes a first mode valve 174 operatively associated with the cold water inlet 171 and the second inlet 136, and a second mode valve 176 operatively associated with the first outlet 104, the second outlet 134, and an outlet coupling pipe 182. The mode valves 174 and 176 are controlled by a control line 178 coupled to the first controller 108.

In the first mode, the first mode valve 174 blocks the flow of water from the cold water inlet 171 to the second inlet 136, and the second mode valve 176 blocks the flow of water from the second outlet 134 to the outlet pipe 182. Thus the first tank 102 receives water from the cold water inlet 171 and provides heated water to the outlet pipe 182 from the first outlet 104, as indicated by arrow 196. The second tank 132 is disconnected.

In the second mode, however, the first mode valve 174 allows the flow of water from the cold water inlet 171 to the second inlet 136, as indicated by arrow 198, and the second mode valve 176 allows the flow of water from the second outlet 134 to the outlet pipe 182 as indicated by arrow 200. Thus, in the second mode the first and second tanks 102 and 132 are connected in parallel. In all other respects, the water heater 800 operates in a similar manner as the embodiments of FIGS. 1-7.

The first and second tanks 102 and 132 may also be connected in different configurations than those shown in FIGS. 8 and 9. Mode valves may be operatively associated with the first outlet 104, the first inlet 106, the second outlet 134, the second inlet 106, and a cold water inlet and a hot water outlet to selectively associate the first and second tanks 102 and 132 in each of the first and second modes. Thus, additional mode valves may be added so that the first and second tanks 102 and 132 are interchanged. For example, instead of a parallel or series connection, the multi-tank water heater may select the first tank 102 in a first mode and the second tank 138 in a second mode. Thus, heated water may be provided only from a smaller first tank 102 in a first mode, and may provided only from a larger second tank 132 in a second mode.

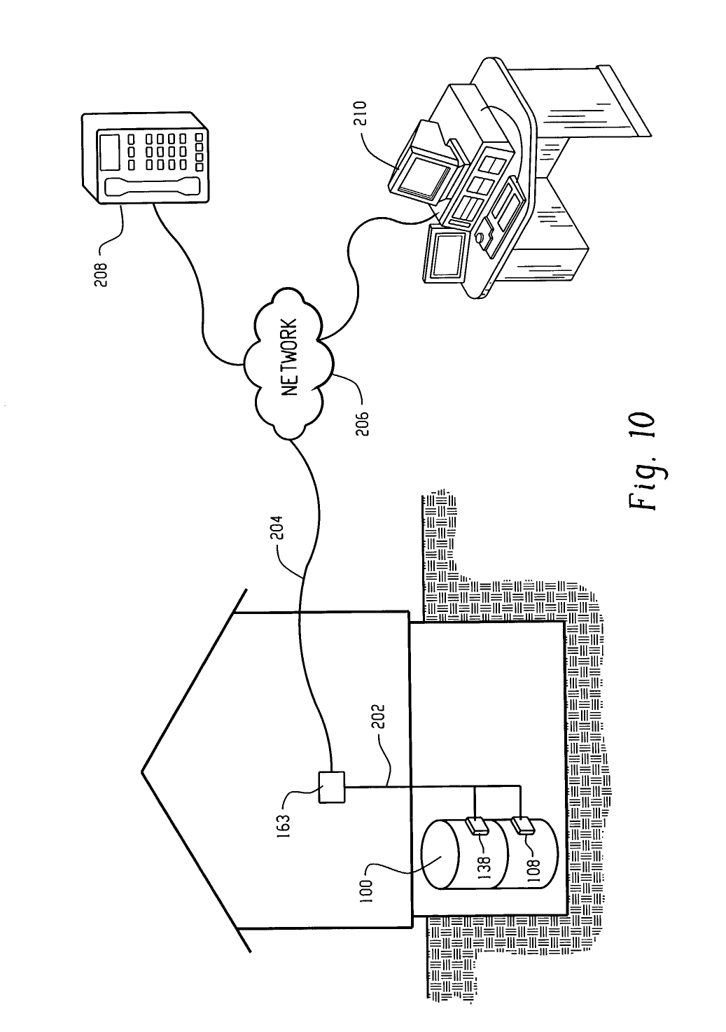

Upon switching from the first mode to the second mode, it will take time for the unheated water stored in the second tank 132 to reach a fully heated stated. Thus, a user may desire to switch to a second mode some time before the additional heated water capacity is required, such as when the user is at work and not at home. In another embodiment, as shown in FIG. 10, the multi-tank water heater 100 is connected to a remote mode selection device 163 via a first control line 202. The remote mode selection device 163 is further connected to a network 206 via a data link 204. The user may access the remote mode selection device over the network 206 by using a communication device, such as a touch-tone telephone 208 or a computer 210. Thus, if a user determines that a heightened demand for heated water will be required in the evening, and the user is away from the household, the user may remotely access the remote mode selection device 163 and switch the water heater 100 to the second mode several house before the heightened demand is required. Additionally, because the remote mode selection device 163 is located on the main floor of the household, the user may switch the water heater 100 back to the first mode without entering the basement, where the water heater 100 is located.

While the embodiments thus described show only a first tank 102 and a second tank 103, the multi-tank water heater may also include more than two tanks. For example, three 25 gallon tanks could be connected in series in the same manner as depicted in FIGS. 1 and 6. Thus, the multi-tank water heater would have three modes: a first mode for heating 25 gallons of water, a second mode for heating 50 gallons of water, and a third mode for heating 75 gallons of water. Other configurations are likewise possible.

The embodiments described herein are examples of structures, systems or methods having elements corresponding to the elements of the invention recited in the claims. This written description may enable those of ordinary skill in the art to make and use embodiments having alternative elements that likewise correspond to the elements of the invention received in the claims. The intended scope of the invention thus includes other structures, systems or methods that do not differ from the literal language of the claims, and further includes other structures, systems or methods with insubstantial differences from the literal language of the claims.

What is claimed is:

1. A water heater for providing heated water to one or more users, the water heater comprising:
a first tank for storing water in a heated state and for providing water in the heated state during a first selected mode and during a second selected mode;
a second tank for storing water in an unheated state during the first selected mode and for storing water in a heated state and for providing water in the heated state during a second selected mode;
a shell enclosing the first tank and the second tank; and
a mode selection device operable to switch between the first selected mode and the second selected mode.

2. The water heater of claim 1, further comprising:
a first heating device operable to heat water stored in the first tank to the heated state during the first and second selected modes; and
a second heating device operable to heat water stored in the second tank to the heated state during the second selected mode;
wherein the first and second heating devices are enclosed in the shell.

3. The water heater claim 2, wherein:
the first tank further comprises an first inlet and a first outlet, the first inlet for receiving water, and the first outlet for providing water in the heated state; and
the second tank further comprises a second inlet and a second outlet, the second inlet for receiving water, and the second outlet connected to the first inlet and for providing water in the unheated state during the first selected mode and for providing water in the heated state during the second selected mode.

4. The water heater of claim 3, wherein the mode selection device switches to the first selected mode by disabling activation of the second heating device, and switches to the second selected mode by enabling activation of the second heating device.

5. The water heater of claim 4, wherein the mode selection device comprises a switch located on the shell of the water heater.

6. The water heater of claim 4, wherein the mode selection device comprises a switch located remotely from the water heater.

7. The water heater of claim 4, wherein the mode selection device is operable to receive selection data over a network, the selection data operable to cause the mode selection device to switch between the first selected mode and the second selected mode.

8. The water heater of claim 2, wherein the first and second heating devices comprise electric heating elements.

9. The water heater of claim 2, wherein the first and second heating devices comprise fuel burners.

10. The water heater of claim 9, wherein the first tank is vertically disposed and above the second tank, and wherein the shell further comprises a plurality of combustion openings adjacent the fuel burners.

11. The water heater of claim 2, wherein the first heating device comprises a fuel burner and the second heating device comprises an electric heating element.

12. The water heater of claim 11, wherein the first tank is vertically disposed and above the second tank, and wherein the shell further comprises a plurality of combustion openings adjacent the fuel burner.

13. The water heater of claim 2, wherein the first tank and the second tank are positioned side-by-side in the shell.

14. The water heater of claim 2, wherein the first tank is vertically disposed and above the second tank.

15. The water heater of claim 3, further comprising an outer tank hull, and wherein the first tank and the second tank are located in the outer tank hull.

16. The water heater of claim 3, wherein the second tank defines a circular interior region, and wherein the first tank is received in the circular interior region.

17. The water heater of claim 16, further comprising insulation for insulating the first tank from the second tank.

18. The water heater of claim 2, wherein the mode selection device comprises:
a first heating device controller operable to control the first heating device;
a second heating device controller operable to control the second heating device; and
a switch operable to switch to the first selected mode by disabling second heating device controller, and further operable to switch to the second selected mode by enabling the second heating device controller.

19. The water heater of claim 1, wherein the first tank receives water from the second tank in the first selected mode and the second selected mode.

20. The water heater of claim 1, further comprising a plurality of mode valves operatively associated with the first and second tanks to direct water flow in a first path during the first selected mode and direct water flow in a second path during the second selected mode.

21. The water heater of claim 20, and wherein:
the first tank further comprises a first inlet and a first outlet, the first inlet for receiving water, and the first outlet for providing water;
the second tank further comprises a second inlet and a second outlet, the second inlet for receiving water, and the second outlet for providing water; and
wherein the mode valves are operatively associated with the first inlet, the second inlet, and the second outlet so that the first tank and the second tank are series connected during the second selected mode.

22. The water heater of claim 20, and wherein:
the first tank further comprises a first inlet and a first outlet, the first inlet for receiving water, and the first outlet for providing water;
the second tank further comprises a second inlet and a second outlet, the second inlet for receiving water, and the second outlet for providing water; and
wherein the mode valves are operatively associated with the first outlet, the second inlet, and the second outlet so that the first tank and the second tank are parallel connected during the second selected mode.

23. A water heater, comprising:
a first tank for storing and providing heated water in a first mode and in a second mode;
a second tank for storing unheated water in the first mode and for storing and providing heated water in the second mode; and
a shell enclosing the first and second tanks.

24. The water heater of claim 23, further comprising:
a mode selection device operable to switch between the first mode and the second mode.

25. The water heater of claim 24, further comprising:
a first heating device operable to heat water stored in the first tank during the first and second modes; and
a second heating device operable to heat water stored in the second tank during the second mode;
wherein the first and second heating devices are enclosed in the shell.

26. The water heater of claim 25, wherein the mode selection device disables activation of the second heating device during the first mode, and enables activation of the second heating device during the second mode.

27. The water heater of claim 26, wherein the mode selection device comprises a switch located on the shell of the water heater.

28. The water heater of claim 26, wherein the mode selection device comprises a switch located remotely from the water heater.

29. The water heater of claim 26, wherein the mode selection device is operable to receive selection data over a network, the selection data causing the mode selection device to switch between the first mode and the selected mode.

30. The water heater of claim 25, wherein the first and second heating devices are electric heating elements.

31. The water heater of claim 25, wherein the first and second heating devices are fuel burners.

32. The water heater of claim 25, wherein the first tank is vertically disposed and above the second tank.

33. The water heater of claim 25, wherein the first tank and the second tank are positioned side-by-side in the shell.

34. The water heater of claim 25, further comprising an outer tank hull, and wherein the first tank and the second tank are located in the outer tank hull.

35. The water heater of claim 34, wherein the second tank defines a circular interior region, and wherein the first tank is received in the circular interior region.

36. A water heater, comprising:
a first tank for storing and providing heated water in a first mode and in a second mode;
a second tank for storing and providing heated water in the second mode;
a mode selection device operable to switch between the first mode and the second mode; and
a shell enclosing the first and second tanks.

37. The water heater of claim 36, further comprising:
a first heating device operable to heat water stored in the first tank during the first and second modes; and
a second heating device operable to heat water stored in the second tank during the second mode;
wherein the first and second heating devices are enclosed in the shell.

38. The water heater of claim 37, wherein the mode selection device disables activation of the second heating device during the first mode, and enables activation of the second heating device during the second mode.

39. The water heater of claim 38, wherein the mode selection device comprises a switch located on the shell of the water heater.

40. The water heater of claim 39, wherein the first and second heating devices are electric heating elements.

41. The water heater of claim 37, further comprising a plurality of mode valves operatively associated with the first and second tanks to direct water flow in a first path during the first mode and direct water flow in a second path during the second mode.

42. The water heater of claim 41, wherein:
the first tank further comprises a first inlet and a first outlet, the first inlet for receiving water, and the first outlet for providing water;
the second tank further comprises a second inlet and a second outlet, the second inlet for receiving water, and the second outlet for providing water; and
wherein the mode valves are operatively associated with the first inlet, the second inlet, and the second outlet so that the first tank and the second tank are series connected during the second mode.

43. The water heater of claim 41, wherein:
the first tank further comprises a first inlet and a first outlet, the first inlet for receiving water, and the first outlet for providing water;
the second tank further comprises a second inlet and a second outlet, the second inlet for receiving water, and the second outlet for providing water; and
wherein the mode valves are operatively associated with the first outlet, the second inlet, and the second outlet so that the first tank and the second tank are parallel connected during the second mode.

44. A water heater, comprising:
a hot water outlet for providing heated water;
a cold water inlet for receiving unheated water;
a first tank for storing and providing heated water in a first mode, the first tank comprising a first inlet and a first outlet;
a second tank for storing and providing heated water in a second mode, the second tank comprising a first inlet and a first outlet;
a mode selection device operable to switch between the first mode and the second mode;
a plurality of mode valves operatively associated with the first inlet, the second inlet, the first outlet, the second outlet, the hot water outlet and the cold water inlet to selectively associate the first and second tanks with the cold water inlet and the hot water outlet in each of the first and second modes; and
a shell enclosing the first and second tanks.

45. The system of claim 44, further comprising:
a first heating device operable to heat water stored in the first tank to the heated state during at least the first selected modes; and
a second heating device operable to heat water stored in the second tank to the heated state during at least the second selected mode;
wherein the first and second heating devices are enclosed in the shell.

46. The system of claim 45, wherein the mode valves selectively associate the first tank to provide heated water during the first mode only, and selective associate the second tank to provide heated water during the second mode only.

47. The system of claim 45, wherein the mode valves selectively associate the first tank to provide heated water during the first and second modes, and selective associate the second tank to provide heated water during the second mode only.

48. The system of claim 47, wherein the mode valves selective associate the second tank to provide heated water during the second mode only by connecting the second tank in parallel with the first tank.

49. The system of claim 47, wherein the mode valves selective associate the second tank to provide heated water during the second mode only by connecting the second tank in series with the first tank.
